(19) United States
(12) Patent Application Publication
(10) Pub. No.: US 2006/0204815 A1
(43) Pub. Date: Sep. 14, 2006

(54) Cell stack having sub-stacks with opposite orientations

(75) Inventor: Duhane Lam, Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: Angstrom Power Incorporated, North Vancouver (CA)

(21) Appl. No.: 11/075,919

(22) Filed: Mar. 10, 2005

(51) Int. Cl. H01M 8/24; C25B 9/18

(52) U.S. Cl. 429/34; 429/32; 204/267

(57) ABSTRACT

A fuel cell stack has two or more sub-stacks of series-connected unit cells. At least two of the sub-stacks are oriented in opposite directions. Distal ends of the sub-stacks may be electrically connected to end plates of the fuel cell stack. The end plates may compress the unit cells and serve as a common electrode of the sub-stacks.

### TECHNICAL FIELD

The invention relates to electrochemical cells. The invention has particular application to fuel cell stacks.

### BACKGROUND

Fuel cells convert a fuel, such as hydrogen or methanol, into electricity by way of electrochemical reactions that occur at anode and cathode regions of the fuel cell. The voltage of a single fuel cell is typically less than 1.2 volts. To achieve desired voltages it is common to connect a number of fuel cells in series with one another.

FIG. 1 is a schematic view of a unit fuel cell 10. Fuel cell 10 has a positive output 12 connected to a cathode 14 and an anode 16 connected to a negative output 19. A layer of an electrolyte 18 separates cathode 14 from anode 16. Fuel cell 10 includes suitable mechanisms (not shown) to make available a fuel at anode 16 and an oxidant at cathode 14. Some fuel cells use hydrogen gas as a fuel and air as an oxidant. Fuel cell 10 includes suitable catalysts to promote electricity-producing electrochemical reactions.

While fuel is supplied to anode 16 and oxidant is supplied to cathode 14, fuel cell 10 produces electricity. Fuel is typically supplied through gas channels in a separator plate (not shown in FIG. 1) adjacent to the fuel cell. Alternatively, fuel can be supplied at edges of anode 16 and an oxidant can be supplied at edges of cathode 14. The fuel and oxidant can be allowed to diffuse into the cathode and anode areas respectively. Many arrangements for providing fuel and oxidant to the anodes and cathodes respectively of fuel cells are also possible. For example, Kubota et al., U.S. Pat. No. 6,818,338, discloses a fuel cell assembly in which the fuel and oxidant are distributed to gas diffusion electrode layers in a grid pattern.

Fuel cell systems commonly include a number of individual unit fuel cells arranged in a stack. A conventional fuel cell stack typically comprises two end plates and two or more unit fuel cells stacked on top of each other and hooked up in series between the end plates. Arranging fuel cells in a stack is convenient because it permits an array of fuel cells to be made up layer-by layer. A typical fuel cell stack comprises a number of unit cells separated by bipolar plates. Each bipolar plate forms the positive side of one fuel cell and the negative side of an adjacent fuel cell. The use of bipolar plates permits all of the fuel cells in a stack to be electrically interconnected in series with one another.

Fuel cells can also be arranged side-to-side in a planar manner, but planar arrays of fuel cells typically require electrical current from each fuel cell to be collected at edges of the fuel cell. A bipolar arrangement is typically preferable over an arrangement that requires edge-collection because electrical resistance can be more effectively minimized in a bipolar stack arrangement.

FIG. 2 is a schematic view of a prior art fuel cell system 20. System 20 comprises a fuel cell stack 21 compressed between end plates 22A and 22B. Bolts 23 clamp end plates 22A and 22B together. Compressing stack 21 helps to provide seals between adjacent layers of stack 21. The seals may prevent the escape of fuel, for example.

Stack 21 comprises a plurality of unit fuel cells 24 each constructed generally as shown in FIG. 1 with a cathode 14, electrolyte 18 and anode 16. A bipolar separator plate 26 is disposed between each pair of adjacent unit cells 24. A positive end plate 27 and a negative end plate 28 are located at positive and negative ends of stack 21. Electrical insulators 29 are provided between plate 22A and positive end plate 27 and between plate 22B and negative end plate 28.

A fuel cell must be designed to produce an electrical output having a voltage and current suitable for the application in which the fuel cell is to be used. The voltage of a stack of fuel cells can be controlled by selecting an appropriate number of cells in the stack. Current capacity can be controlled by making the active area of each fuel cell of a suitable size. To achieve more current from fuel cells of a certain active area, several stacks can be connected in parallel. Yamanis, U.S. Pat. No. 6,589,681 discloses an example system having two fuel cell stacks electrically connected in parallel with one another, for example.

Scartozzi, U.S. Pat. No. 6,703,155 discloses a power tap device for a fuel cell stack. The power tap device can be inserted between two separator plates in a fuel cell stack to break the fuel cell stack into a number of segments that are electrically separated from one another. In one example, a fuel cell stack having unit fuel cells that would produce 30 volts when connected in series is broken into ten 3 volt segments with power tap devices.

There is a need for fuel cell systems that are cost effective and provide desired electrical output characteristics. There is also a need for fuel cell systems that are compact.

### SUMMARY OF THE INVENTION

One aspect of the invention provides a stack of electrochemical cells, such as fuel cells, comprising a plurality of unit electrochemical cells arranged in at least two sub-stacks. Within each of the sub-stacks the unit cells are electrically connected in series with one another. The two sub-stacks are oriented in opposite directions. In some embodiments, the two sub-stacks are electrically connected in parallel.

Further aspects of the invention and features of specific embodiments of the invention are described below.

### BRIEF DESCRIPTION OF THE DRAWINGS

In drawings which illustrate non-limiting embodiments of the invention:

FIG. 1 is a schematic view of a prior art fuel cell;

FIG. 2 is a schematic view of a prior art fuel cell system incorporating a stack of fuel cells;

FIG. 3 is a schematic view of a fuel cell system according to an embodiment of the invention;

FIG. 3A is an electrical schematic diagram of a system like that of FIG. 3 but having more sub-stacks;

FIG. 4 is a schematic view of a fuel cell system according to an alternative embodiment of the invention;

FIG. 4A is an electrical schematic diagram of the system of FIG. 4;

FIG. 5 is a schematic view of a fuel cell system according to another alternative embodiment of the invention;

FIG. 6 is a schematic view of a fuel cell system according to yet another alternative embodiment of the invention; and, FIG. 6A is a section in the plane 6A-6A of FIG. 6 of the fuel cell system of FIG. 6.

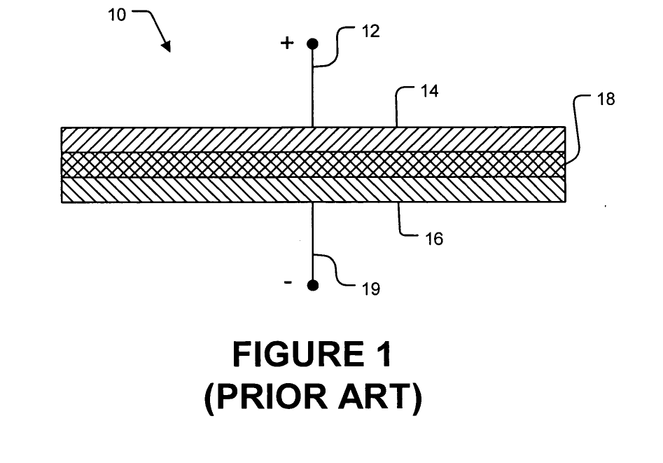

In all of the drawings, the thicknesses of the various illustrated layers are not meant to indicate any scale or to represent relative thicknesses of different layers.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

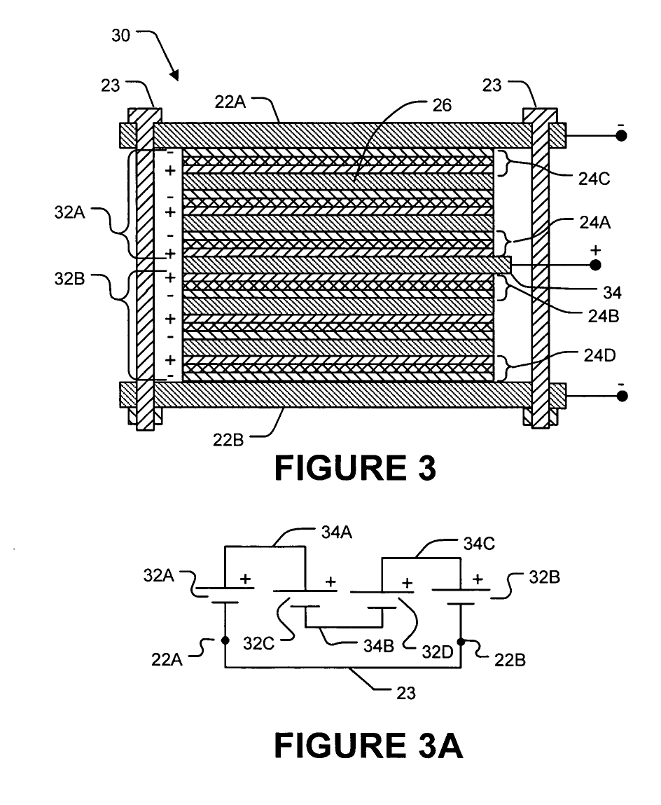

FIG. 3 shows a parallel-serial fuel cell stack 30 according to an embodiment of the invention. Stack 30 is divided into sub-stacks 32A and 32B. In sub-stack 32A, unit cells 24 are oriented with their cathodes toward end plate 22A. In sub stack 32B, unit cells 24 are oriented with their cathodes toward end plate 22B. Sub-stacks 32A and 32B are arranged back-to back. The electrical polarities of unit cells 24 in sub-stacks 32A and 32B are oriented in opposite directions.

Unit cells 24 may be of any suitable type. For example, unit cells 24 may comprise PEM (polymer electrolyte membrane) fuel cells. Depending upon the type of unit cells 24 suitable systems (not shown) may be provided to perform functions such as:
introducing fuel,
introducing oxidizing agent,
cooling the unit cells,
collect, control or remove contaminants that may enter the unit cells,
and so on.
   Such systems are known to those skilled in the art and are not described herein.

In some embodiments each unit fuel cell 24 is relatively small. For example, each unit cell 24 may have an active area of 10 cm² or less, 1 cm² or less in some embodiments. The ability to readily connect sub-stacks of unit fuel cells in parallel with one another permits such smaller unit cells to be used even in cases where a load draws a large electrical current. Fuel cell stacks according to the invention could also be made with larger fuel cells.

The cathodes of each of unit cells 24A and 24B are in electrical contact with a common positive terminal plate 34. The anode of unit cell 24C is in electrical contact with end plate 22A. The anode of unit cell 24D is in electrical contact with end plate 22A. In this embodiment of the invention, end plates 22A and 22B are electrically conducting and serve as negative electrical terminal plates. The end plates may, for example, be of aluminum or other suitable metals.

Fuel cell sub-stacks 32A and 32B may be connected in parallel by providing an electrically conductive connection between end plates 22A and 22B. In the illustrated embodiment bolts 23 are electrically conductive and provide such an electrical connection. In other embodiments a wire or buss bar (not shown) provides an electrical connection between end plates 22A and 22B.

The embodiment illustrated in FIG. 3 has only six unit fuel cells. The exact number of unit cells can be varied to provide a desired electrical voltage output. For example, each sub stack 32 could include tens of unit cells or even more. If sub-stacks 32A and 32B are to be connected in parallel electrically then the voltages of sub-stacks 32A and 32B should be substantially the same. It is generally preferable for sub-stacks 32A and 32B to have equal numbers of unit cells 24. In such embodiments, common plate 34 is half-way along fuel cell system 30.

In an alternative embodiment of the invention, the function of common plate 34 is provided directly by cathode layers of central adjacent unit fuel cells 24A and 24B. In some embodiments, central unit fuel cells 24A and 24B share a common cathode layer that also serves as a positive terminal for each of sub-stacks 32A and 32B. Similarly, some embodiments of the invention may lack separators 26 between adjacent unit fuel cells 24 of sub-stacks 32A and/or 32B. In such embodiments, the unit fuel cells include barriers that prevent fuel from migrating from the anode of one unit cell to the cathode of an adjacent unit cell.

Fuel cell systems like system 30 may be made with opposite polarity to that shown in FIG. 3 (i.e. with a central negative terminal and positive terminals at distal ends of each sub-stack) by reversing the polarities of each of the unit cells.

Fuel cell systems in which end plates 22A and 22B are electrically common to sub-stacks at either end of a fuel cell stack may include more than two sub-stacks. For example, a fuel cell stack like that used in system 30 may have any practical even number of sub-stacks. The polarity of the sub-stacks can alternate along the stack. Each pair of adjacent sub-stacks may share a common plate like plate 34. FIG. 3A shows the electrical layout of such a system having four sub-stacks of fuel cells 32A through 32D. It should be remembered that each sub-stack comprises a plurality of series-connected unit cells 24. Unit cells 24 are not shown in FIG. 3A for clarity. All of the sub-stacks shown in FIG. 3A could be connected in parallel with one another by providing an electrical connection between plates 34A and 34C and another electrical connection between plate 34B and end plates 22A and 22B.

The number of unit cells in sub-stacks 32A and 32B does not need to be exactly equal. Sub-stacks 32A and 32B may be connected in parallel with one another if their potentials are substantially the same. For example, for many applications, sub-stack 32A could have one more or one fewer unit cell than sub-stack 32B without causing any problems.

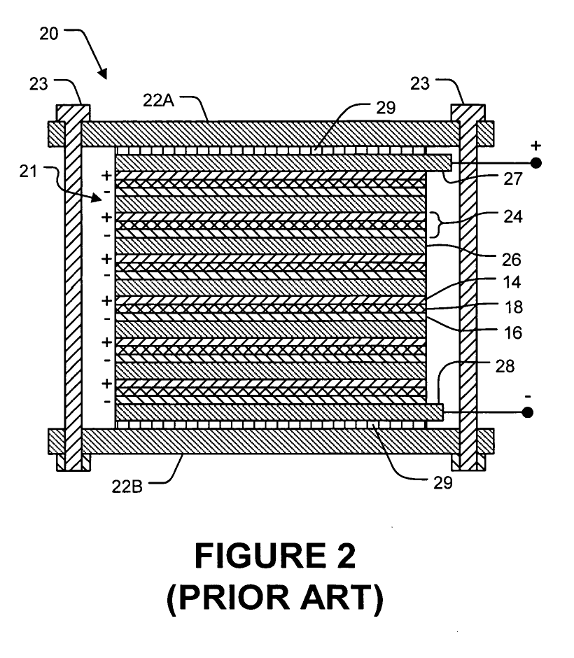

Some advantages of the embodiment illustrated in FIG. 3 are:
End plates 22A and 22B are used as an electrical terminals for system 30.
Because the two end plates are at the same electrical potential, connecting them together electrically through bolts 23 presents no problems. There is no need to use electrically insulating bolts or to isolate bolts 23 from one or both of end plates 22A and 22B.
A number of parts are eliminated in comparison to system 20 of FIG. 2. Fuel cell systems according to the invention can be simplified in comparison to conventional serial stacks.

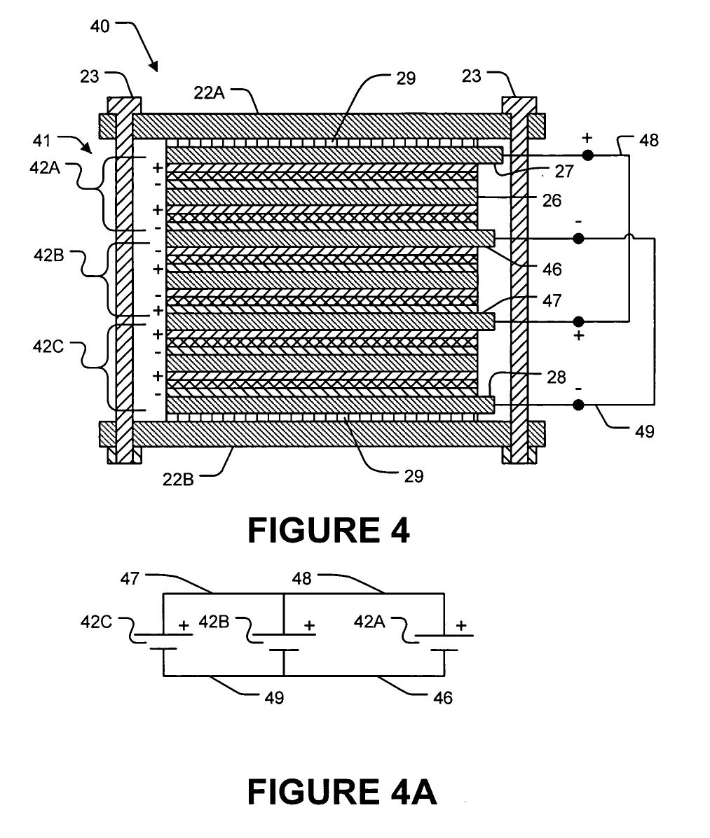

FIG. 4 shows a fuel cell system 40 according to another embodiment of the invention. System 40 has a plurality of sub-stacks 42A, 42B, and 42C (collectively sub-stacks 42). Three sub-stacks are shown. Because stack 41 has an odd number of sub-stacks, the ends of stack 41 do not have equal potentials. This would be the case for a stack having any odd number of sub-stacks with an equal number of unit cells in each sub-stack. Each sub-stack 42 has one or more unit fuel cells. The sub-stacks shown in FIG. 4 have two unit fuel cells each for simplicity of illustration. Typically each sub-stack would have more unit cells.

In system 40 at least one fuel cell sub-stack 42 is oriented in a direction opposite to another fuel cell sub-stack 42. For example, the unit cells of sub-stack 42B are oriented in a direction opposite to the orientation of unit cells in either of sub-stacks 42A and 42C.

Since the ends of stack 41 are not at equal electrical potentials, the end plates must be electrically insulated from each other or one or both of end plates 22A and 22B must be electrically insulated from the stack. The embodiment shown has electrical insulators 29 separating the ends of stack 41 from end plates 22A and 22B.

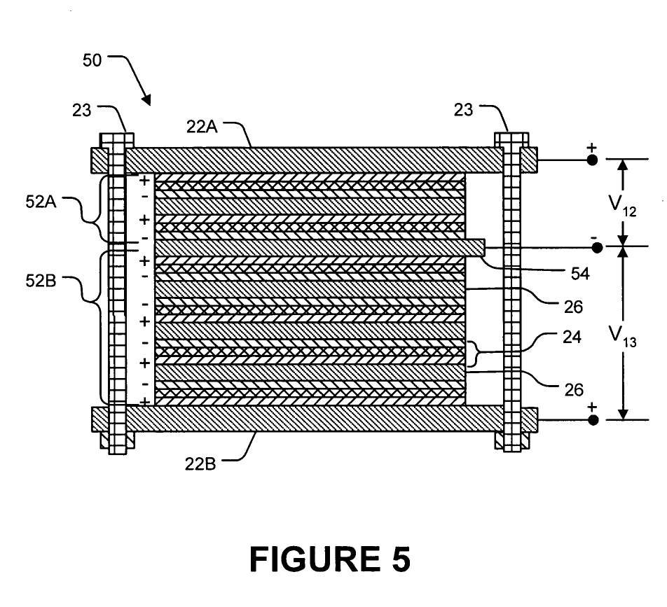

FIG. 5 shows a fuel cell system 50 according to yet another embodiment of the invention. System 50 has a fuel cell stack 51 made up of two sub-stacks 52A and 52B. Unlike the sub-stacks described above, sub-stacks 51A and 51B have unequal numbers of unit cells. Sub-stacks 52A and 52B are oriented in opposite directions. Negative ends of both of sub-stacks 52A and 52B are electrically connected to a common plate 54 lying between sub-stacks 52A and 52B.

The positive end of sub-stack 52A is connected to end plate 22A while the positive end of sub-stack 52B is electrically connected to end plate 22B. In the illustrated embodiment, end plates 22A and 22B are electrically insulated from one another and bolts 23 are non-conducting (or electrically insulated from at least one of end plates 22A and 22B). A potential difference V₁₂ is provided between end plate 22A and common plate 54. A different potential difference V₁₃ is provided between end plate 22B and common plate 54. As noted above in the discussion of FIG. 3, if V₁₂ and V₁₃ are substantially equal to one another then sub-stacks 52A and 52B could be connected in parallel with one another.

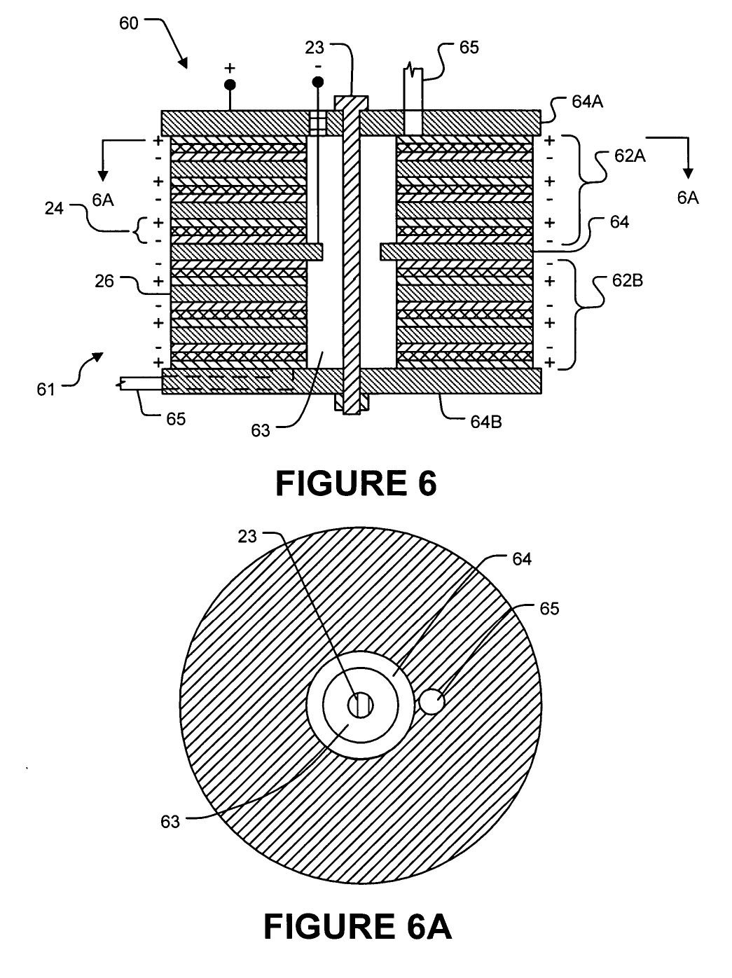

FIG. 6 is a schematic view of a fuel cell system 60 comprising a parallel-serial stack 61. Stack 61 has a central aperture 63. As shown in FIG. 6A, stack 61 may be cylindrical with circular layers. Other cross-sectional shapes are possible. Stack 61 is compressed between end plates 64A and 64B. A bolt 23 can be tightened to draw end plates 64A and 64B together.

In fuel cell system 60, the unit fuel cells shown are diffusion-based. A suitable fuel such as hydrogen is fed into one of gas ports 65. The fuel is carried into manifolds within stack 61 from where it can diffuse into the anode-layer of each unit fuel cell. Oxidant, in this case ambient air from the environment, diffuses into the cathode layers of each unit fuel cell from the outside. Other suitable arrangements for supplying fuel and oxidant to the anode and cathode layers of the unit fuel cells could also be used.

System 60 comprises two sub-stacks, 62A and 62B (collectively sub-stacks 62). Each sub-stack 62 has three unit fuel cells 24 that are electrically connected in series with one another. Different combinations and numbers of sub-stacks and unit fuel cells per stack are also possible.

A distal end of sub-stack 62A is in electrical contact with end plate 64A. A distal end of sub-stack 64B is in contact with end plate 64B. End plates 64A and 64B constitute a positive terminal of system 60. A bus separator 64 between sub-stacks 62A and 62B connects medial ends of the two sub-stacks electrically and forms the negative terminal of system 60. By reversing the orientation of the unit cells 24 of both sub-stacks 62, end plates 64A and 64B could be made to be negative terminals of system 60 while the central bus separator 64 could be positive. As described above, bus separator 64 could be integrated with the two anode layers of the adjacent unit fuel cells, reducing number of parts required to make system 60 even further.

As can be appreciated, this invention makes it possible to provide a single fuel cell stack in which unit fuel cells are electrically interconnected in any of many possible parallel-serial circuit connections. The possibilities for unit cell interconnections are illustrated but not limited by the examples shown in the appended drawings and described herein. The invention thereby enables fuel cell system designers to configure the output voltage and current of a single stack of a given type of unit fuel cell to match a desired load.

Particular flexibility is achieved in cases where more current and lower voltages are required. Rather than using a number of shorter fuel cell stacks in parallel, one stack can be built with only one set of end plates. This reduces the number of parts required to make the fuel cell system and increases the volumetric density of the stack.

The invention may be applied to fuel cells having atypical stack constructions. For example, the invention may be applied to fuel cells of the type described in any of the following commonly-owned patent and patent applications:
U.S. application Ser. No. 11/047,557 entitled ELECTROCHEMICAL CELLS FORMED ON PLEATED SUBSTRATES filed on 2 Feb. 2005;
PCT Application PCT/IB03/00915 entitled APPARATUS OF HIGH POWER DENSITY FUEL CELL LAYER WITH MICRO STRUCTURED COMPONENTS;
U.S. application Ser. No. 10/349,128 entitled APPARATUS OF HIGH POWER DENSITY FUEL CELL WITH MICRO STRUCTURED COMPONENTS;
U.S. application Ser. No. 10/348,867 entitled APPARATUS OF HIGH POWER DENSITY FUEL CELL LAYER WITH MICRO STRUCTURED COMPONENTS;
U.S. Pat. No. 6,864,010 entitled APPARATUS OF HIGH POWER DENSITY FUEL CELL LAYER WITH MICRO STRUCTURED COMPONENTS FOR CONNECTING TO AN EXTERNAL LOAD;
U.S. application Ser. No. 10/349,338 entitled ELECTROCHEMICAL CELL;
U.S. application Ser. No. 10/349,459 entitled METHOD OF MANUFACTURING HIGH POWER DENSITY FUEL CELL LAYERS WITH MICRO STRUCTURED COMPONENTS;
U.S. application Ser. No. 10/349,127 entitled FUEL CELL SYSTEM;
U.S. application Ser. No. 10/349,133 entitled HIGH POWER DENSITY FUEL CELL STACK USING MICRO STRUCTURED COMPONENTS;
U.S. application Ser. No. 10/887,519 entitled THIN-LAYER FUEL CELL STRUCTURE;
U.S. application Ser. No. 10/818,780 entitled COMPACT CHEMICAL REACTOR;
U.S. application Ser. No. 10/818,610 entitled COMPACT CHEMICAL REACTOR WITH REACTOR FRAME;
U.S. application Ser. No. 10/818,826 entitled METHOD FOR MAKING COMPACT CHEMICAL REACTORS;
U.S. application Ser. No. 10/818,611 entitled COMPACT FUEL CELL LAYER;
U.S. application Ser. No. 10/818,843 FUEL CELL LAYER WITH REACTOR FRAME; or,
U.S. application Ser. No. 10/818,612 METHOD FOR FORMING COMPACT CHEMICAL REACTORS WITH REACTOR FRAMES;
   all of which are hereby incorporated by reference herein.

The parallel/serial stack configuration of cells that can be facilitated in embodiments of the invention is particularly attractive for small diffusion-based fuel cells. The active area of such fuel cells is typically limited by the ability of gases to diffuse through a gas diffusion media. Thus, each unit cell can typically deliver only a low current. Stacks of diffusion-based fuel cells can be used to run small low-voltage loads. Such fuel cells may be arranged in a stack according to the invention having a number of sub-stacks between one pair of end plates. The sub-stacks can be connected in parallel to produce a required current. The overall arrangement can have a high energy density since only one set of end plates is required.

A further advantage of a stack that includes parallel connections between unit cells in the stack is that such a stack can provide a certain degree of redundancy and fault tolerance. In a conventional stack, where all unit cells are connected in series, an open-circuit failure of any one unit fuel cell will cause the entire stack to fail. If the fuel cell stack is configured as a parallel-serial fuel cell stack, such an open-circuit failure of a unit fuel cell only leads to failure of a single sub-stack. The rest of the stack can continue to function, if at a diminished power level.

Where a component (e.g. a unit cell, plate, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

As will be apparent to those skilled in the art in the light of the foregoing disclosure, many alterations and modifications are possible in the practice of this invention without departing from the spirit or scope thereof. For example:
Although the embodiments illustrated herein use bolts to compress fuel cell stacks, other constructions may be provided to compressed fuel cell stacks in embodiments of the invention. For example, Blanchet, U.S. Pat. No. 6,797,425, discloses a compression system used in conjunction with a fuel cell stack having first and second ends and contained within a vessel. Other methods for compression are also possible.
The architecture described herein could be used for stacks of electrolysis cells (electrolyzers) as well as fuel cells.
   Accordingly, the scope of the invention is to be construed in accordance with the substance defined by the following claims.

What is claimed is:

1. A stack of electrochemical cells comprising four or more unit electrochemical cells arranged in a plurality of sub-stacks, each of the sub stacks comprising a plurality of the unit electrochemical cells electrically interconnected in series with one another, wherein the unit electrochemical cells of first and second ones of the sub-stacks are oriented in opposite directions.

2. A stack of electrochemical cells according to claim 1 wherein the unit electrochemical cells are fuel cells and the stack constitutes a fuel cell stack.

3. A fuel cell stack according to claim 2 wherein the first and second sub-stacks are adjacent to one another in the fuel cell stack and share a common electrical connection between the sub-stacks.

4. A fuel cell stack according to claim 2 wherein a medial end of the first sub-stack is electrically connected to a medial end of the second sub-stack.

5. A fuel cell stack according to claim 2 wherein a distal end of the first sub-stack is electrically connected to a distal end of the second sub-stack.

6. A fuel cell stack according to claim 5 wherein the unit cells are compressed between a pair of electrically conducting end plates, the distal end of the first sub-stack is in contact with a first one of the end plates and the distal end of the second sub-stack is in contact with a second one of the end plates.

7. A fuel cell stack according to claim 5 wherein the first and second sub-stacks are connected in parallel with one another.

8. A fuel cell stack according to claim 2 wherein the unit cells are compressed between a pair of electrically conducting end plates, the distal end of the first sub-stack is in contact with a first one of the end plates and the distal end of the second sub-stack is in contact with a second one of the end plates.

9. A fuel cell stack according to claim 8 wherein the end plates are electrically connected to one another.

10. A fuel cell stack according to claim 2 wherein the first and second sub-stacks have different numbers of unit cells.

11. A fuel cell stack according to claim 2 wherein the first and second sub-stacks are connected in parallel with one another.

12. A fuel cell stack according to claim 2, wherein the unit fuel cells are PEM fuel cells.

13. A fuel cell stack according to claim 2, wherein the unit fuel cells are diffusion-based fuel cells.

14. A fuel cell stack according to claim 2 wherein an active area of each of the unit fuel cells is 10 cm² or less.

15. A fuel cell stack according to claim 14 wherein the active area of each unit fuel cell is 1 cm² or less.

16. A fuel cell stack according to claim 2 wherein the stack has an odd number of sub-stacks and the sub-stacks are electrically connected in parallel with one another.

17. A fuel cell stack according to claim 16 wherein the sub-stacks alternate in orientation along the fuel cell stack.

18. A fuel cell stack according to claim 2 comprising three or more sub-stacks a first end plate at one end of the fuel cell stack and a second end plate at another end of the fuel cell stack, wherein:
each of the end plates is electrically conductive,
the first end plate is in electrical contact with an end of the first sub-stack; and,
the second end plate is in electrical contact with an end of the second sub-stack.

19. A fuel cell stack according to claim 18 wherein the first and second end plates have equal potentials.

20. A fuel cell stack according to claim 19 wherein the fuel cell stack is compressed between the first and second end plates.

21. A stack of electrochemical cells according to claim 1 wherein the unit electrochemical cells comprise electrolysis cells.

22. A fuel cell stack comprising two ends and three or more unit fuel cells arranged along the fuel cell stack, each of the unit fuel cells having an anode and a cathode spaced apart from one another along the fuel cell stack wherein the anode of one unit fuel cell is adjacent to and is in electrical contact with the anode of another unit fuel cell or the cathode of one unit fuel cell is adjacent to and in electrical contact with the cathode of another unit fuel cell.
